(19) United States
(12) Patent Application Publication
(10) Pub. No.: US 2012/0120552 A1
(43) Pub. Date: May 17, 2012

(54) ELECTROCHEMICAL CAPACITOR

(75) Inventors: Kanako Ito, Kanagawa (JP); Shinichi Uesaka, Kanagawa (JP)

(73) Assignee: SONY CORPORATION, Tokyo (JP)

(21) Appl. No.: 13/387,315

(22) PCT Filed: Jul. 13, 2010
(86) PCT No.: PCT/JP2010/061819

§ 371 Date: Jan. 26, 2012

(30) Foreign Application Priority Data
Aug. 3, 2009 (JP) 2009-180917

(51) Int. Cl. H01G 9/145

(52) U.S. Cl. 361/503

(57) ABSTRACT

An electrochemical capacitor capable of improving discharge characteristics is provided. A cathode and an anode are laminated with a separator in between. The cathode includes a cathode active material layer on one surface of a cathode current collector, and the anode includes an anode active material layer on one surface of an anode current collector. Both of the cathode active material layer and the anode active material layer include both of an ionic liquid and a polymer compound together with the active materials. Since the ionic liquid is retained by the polymer compound in the cathode and the anode, discharge capacity is less likely to be reduced.

### TECHNICAL FIELD

The present invention relates to an electrochemical capacitor including an electrolyte between a pair of electrodes.

### BACKGROUND ART

In recent years, electrochemical capacitors (electric double layer capacitors) have been widely developed as power supplies for memory backup in electronic devices. The electrochemical capacitor is configured by laminating a pair of electrodes with a separator in between, and the separator is impregnated with an electrolytic solution. It is to be noted that, if necessary, not only the separator but also the electrodes may be impregnated with the electrolytic solution.

Recently, to improve various kinds of performance of the electrochemical capacitor, it is considered to use an ionic liquid instead of the electrolytic solution. In this case, to improve absorptivity of the ionic liquid, the electrode includes the ionic liquid together with a fluorine-containing copolymer resin (for example, refer to PTL 1). Moreover, to improve adhesion between the electrode and an ion-conductive sheet, the ion-conductive sheet includes the ionic liquid together with a polymer compound (refer to PTL 2).

### [Citation List]

### [Patent Literature]

[PTL 1] Japanese Unexamined Patent Application Publication No. 2006-344918

[PTL 2] Japanese Unexamined Patent Application Publication No. 2002-251917

### DISCLOSURE OF THE INVENTION

Although various studies of improvements in performance of electrochemical capacitors, specifically an increase in discharge capacity have been conducted, results from the studies are still insufficient. On the other hand, recently, it is considered to adapt the electrochemical capacitors to not only low-capacity applications such as power supplies for memory backup but also high-capacity applications such as power supplies for vehicles. Therefore, a significant improvement in discharge characteristics of the electrochemical capacitors is desired.

The present invention is made to solve the above-described issues, and it is an object of the invention to provide an electrochemical capacitor capable of improving discharge characteristics.

An electrochemical capacitor according to an embodiment of the invention includes an electrolyte between a pair of electrodes, and the electrodes include an active material, an ionic liquid, and a polymer compound. In the electrochemical capacitor, the ionic liquid is retained by the polymer compound in the electrodes.

In the electrochemical capacitor according to the embodiment of the invention, the electrodes include the ionic liquid and the polymer compound. In this case, compared to the case where the electrodes do not fundamentally include the ionic liquid, or in the case where the electrodes include the ionic liquid, but do not include the polymer compound, discharge capacity is higher. Therefore, discharge characteristics are allowed to be improved.

### BRIEF DESCRIPTION OF THE DRAWINGS

FIG. 1 is a sectional view illustrating a configuration of an electrochemical capacitor according to an embodiment of the invention.

FIG. 2 is a sectional view illustrating another configuration of the electrochemical capacitor according to the embodiment of the invention.

FIG. 3 is a sectional view illustrating a configuration of an electrochemical capacitor in a comparative example.

FIG. 4 is a sectional view illustrating another configuration of the electrochemical capacitor in the comparative example.

FIG. 5 is a diagram illustrating results of a constant-current charge/discharge test.

### BEST MODE(S) FOR CARRYING OUT THE INVENTION

A preferred embodiment of the invention will be described in detail below referring to the accompanying drawings. It is to be noted that description will be given in the following order.

1. Electrochemical capacitor (with separator)
2. Electrochemical capacitor (without separator)

(1. Electrochemical capacitor (with separator))

### [Configuration of Electrochemical Capacitor]

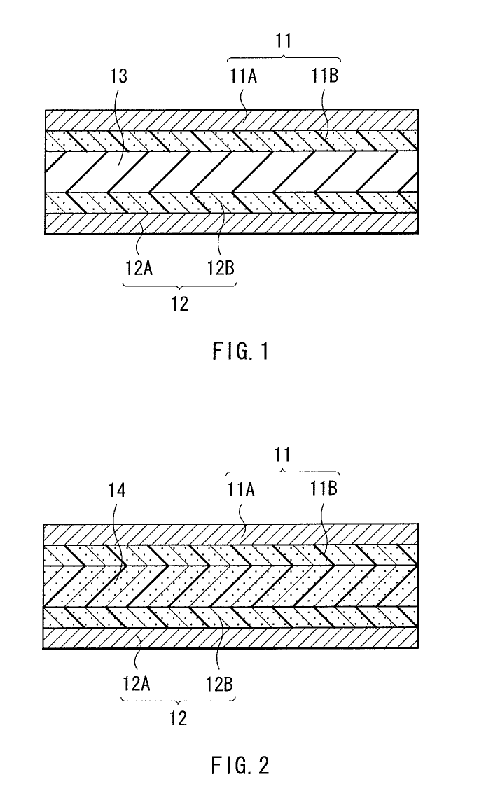

First, a configuration of an electrochemical capacitor according to an embodiment of the invention will be described below. FIG. 1 illustrates a sectional configuration of the electrochemical capacitor.

For example, the electrochemical capacitor described herein is used as a power supply for memory backup in a low-capacity application typified by an electronic device such as a cellular phone or a personal computer. Moreover, the electrochemical capacitor is used in, for example, a high-capacity application typified by a vehicle (a battery, a motor, or the like) such as an electric car and a hybrid electric car. Examples of other applications include power supplies for household use (electric storage devices or battery servers).

The electrochemical capacitor is configured by laminating a cathode 11 and an anode 12 as a pair of electrodes with a separator 13 in between.

The cathode 11 includes, for example, a cathode active material layer 11B on one surface of a cathode current collector 11A. The cathode current collector 11A is made of a metal material such as aluminum (Al). The cathode active material layer 11B includes an active material, an ionic liquid, and a polymer compound, and may include any other material such as a conductive agent, if necessary. It is to be noted that as the above-described active material, ionic liquid, polymer compound, and the like, one kind or two or more kinds thereof may be included.

The cathode active material layer 11B includes the ionic liquid instead of an electrolytic solution (including an electrolyte salt and an organic solvent, and not including a polymer compound), because the ionic liquid is nonvolatile, and does not have issues specific to the electrolytic solution including a volatile organic solvent. The issues specific to the electrolytic solution include an increase in pressure caused by volatilization of the organic solvent, and gas evolution caused by decomposition of the electrolytic solution. All of these issues cause a decline in safety and performance of the electrochemical capacitor.

Moreover, the cathode active material layer 11B includes the polymer compound together with the ionic liquid, because the ionic liquid is retained by the polymer compound in the cathode active material layer 11B. In other words, the ionic liquid and the polymer compound are in a so-called gel state. Therefore, a reduction in discharge capacity due to the ionic liquid in the cathode 11 (a reduction in discharge capacity caused in the case where the ionic liquid is not retained by the polymer compound) is inhibited.

The active material includes a carbon material such as activated carbon. The kind of the activated carbon is not specifically limited, and kinds of the activated carbon include, for example, phenol-based, rayon-based, acrylic-based, pitch-based, and coconut shell-based activated carbons. It is to be noted that conditions including a specific surface area and a particle diameter are arbitrarily specified.

The ionic liquid is called by various terms including ionic liquid, ambient-temperature (type) molten salt, and room-temperature (type) molten salt. It is to be noted that in Europe and the United States, a salt with a melting point of 100° C. or less is called an ionic liquid.

Since a majority of constituent ions of the ionic liquid are organic substances, as the ionic liquid, various derivatives are allowed to be used. Typical properties and functions of the ionic liquid are determined by a combination of a cation and an anion; however, the kind of the ionic liquid used herein (kinds of the cation and the anion) are not specifically limited.

The cation is broadly classified into an aliphatic amine cation and an aromatic amine cation. Examples of the aliphatic amine cation include an ion (DEME) represented by the following formula (1A), and the like. Examples of the aromatic amine cation include an ion (EMI) represented by the following formula (1B), and the like. It is to be noted that R1 and R2 in the formula (1B) are alkyl groups, and may be the same as or different from each other.

The anion is broadly classified into a chloroaluminate anion and a non-chloroaluminate anion. Examples of the chloroaluminate anion include a tetrachloroaluminum ion (AlCl4⁻), and the like. Examples of the non-chloroaluminate anion include a tetrafluoroborate ion (BF4⁻), a trifluoromethanesulfonate ion ((CF₃SO₂)₂N⁻), a nitrate ion (NO₃⁻), and the like.

[Chemical Formula 1]

In particular, an ionic liquid having compatibility with the polymer compound is preferable. It is because the ionic liquid is stably retained by the polymer compound. More specifically, as represented by the following formula (1), a compound (DEME-BF₄) including DEME as the cation and BF4⁻ as the anion is preferable. It is because sufficient conductivity is obtained, and heat resistance is significantly high. More specifically, in the case where the cation is EMI, a reductive decomposition reaction becomes severe at high temperature; therefore, the temperature during charge/discharge is limited to approximately 60° C. On the other hand, in the case where the cation is DEME, a reductive decomposition reaction is inhibited even at high temperature; therefore, charge and discharge are allowed to be performed even at approximately 150° C.

[Chemical Formula 2]

The kind of the polymer compound is not specifically limited; however, a polymer compound having thermoplasticity is preferable. It is because the polymer compound having thermoplasticity is allowed to be easily processed and molded to form the cathode active material layer 11B in a desired shape. For example, as the polymer compound, a copolymer including vinylidene fluoride, more specifically, a copolymer of vinylidene fluoride and hexafluoropropylene (PVDF-HFP) is preferable. In addition, polyvinylidene fluoride (PVDF), polytetrafluoroethylene (PTFE), aromatic polyamide, and the like may be used. It is because they are capable of sufficiently retaining the ionic liquid. It is to be noted that conditions including a copolymerization amount and a molecular weight are arbitrarily specified.

Examples of the conductive agent include carbon materials such as graphite, carbon black, acetylene black, ketjen black, and vapor growth carbon fiber (VGCF). It is to be noted that conditions including a particle diameter is arbitrarily specified.

The anode 12 includes, for example, an anode active material layer 12B on one surface of an anode current collector 12A. The configurations of the anode current collector 12A and the anode active material layer 12B are the same as those of the cathode current collector 11A and the cathode active material layer 11B, respectively. However, the kind of the ionic liquid included in the anode active material layer 12B may be the same as or different from the ionic liquid included in the cathode active material layer 11B. The same applies to the kind of the polymer compound included in the anode active material layer 12B.

The anode active material layer 12B includes the ionic liquid and the polymer compound, because of a similar reason to that in the case of the above-described cathode active material layer 11B. Specifically, the ionic liquid and the polymer compound are in a gel state, and the ionic liquid is retained by the polymer compound in the anode active material layer 12B. Therefore, a reduction in discharge capacity due to the ionic liquid in the anode 12 (a reduction in discharge capacity caused in the case where the ionic liquid is not retained by the polymer compound) is inhibited.

The separator 13 is, for example, a polymer film made of polyethylene or the like, and the separator 13 is impregnated with an ionic liquid which is an electrolyte. Specific description of the ionic liquid is similar to that of the ionic liquid included in the cathode 11 and the anode 12. The kind of the ionic liquid with which the separator 13 is impregnated may be the same as or different from the kind of the ionic liquid included in the cathode 11 and the anode 12.

It is to be noted that in FIG. 1, constituent elements (herein, the cathode active material layer 11B and the anode active material layer 12B) including the ionic liquid and the polymer compound in constituent elements of the electrochemical capacitor are shaded. This is to clarify the constituent elements including the ionic liquid and the polymer compound. The meaning of shading applies to shaded parts in FIGS. 2 and 4 which will be described later.

[Method of Manufacturing Electrochemical Capacitor]

The electrochemical capacitor is manufactured by, for example, the following steps.

First of all, the cathode 11 is formed. First, the active material, the ionic liquid, and the polymer compound, and, if necessary, the conductive agent and a solvent for viscosity adjustment are mixed, and then stirred to form slurry. Next, the cathode current collector 11A is coated with the slurry with use of a coater or the like, and then the slurry is dried (by volatilizing the solvent) to form the cathode active material layer 11B. Next, the cathode active material layer 11B is compression-molded with use of a roller press or the like. Finally, the cathode current collector 11A including the cathode active material layer 11B formed thereon is stamped into a pellet shape.

Next, the anode 12 with a pellet shape is formed by forming the anode active material layer 12B on the anode current collector 12A by similar steps to those of forming the cathode 11.

Finally, the separator 13 is impregnated with the ionic liquid. In this case, to easily impregnate the separator 13 with the ionic liquid, if necessary, the ionic liquid may be diluted with a solvent for viscosity adjustment or the like. After that, the cathode 11 and the anode 12 are laminated to allow the cathode active material layer 11B and the anode active material layer 12B to face each other with the separator 13 in between. Thus, the electrochemical capacitor illustrated in FIG. 1 is completed.

In the electrochemical capacitor, the cathode 11 and the anode 12 include both of the ionic liquid and the polymer compound; therefore, in any cases, the ionic liquid is retained by the polymer compound. Therefore, compared to the case where the ionic liquid is not fundamentally included, or the case where the ionic liquid is included, but is not retained by the polymer compound, the discharge capacity is less likely to be reduced. Therefore, discharge characteristics are allowed to be improved.

In particular, in the case where the ionic liquid is DEME-BF₄, and the polymer compound is PVDF-HFP, a combination (compatibility) thereof is appropriately adjusted; therefore, a higher effect is allowed to be obtained.

Moreover, in the case where the ionic liquid is high heat-resistant DEME-BF₄, the ionic liquid is resistant to decomposition even at high temperature; therefore, discharge characteristics are allowed to be improved stably and safely.

(2. Electrochemical Capacitor (Without Separator))

### [Configuration of Electrochemical Capacitor]

It is to be noted that, in FIG. 1, the separator 13 impregnated with the ionic liquid is included between the cathode 11 and the anode 12. However, as illustrated in FIG. 2, instead of the separator 13, an electrolyte layer 14 may be included. The configuration of an electrochemical capacitor illustrated in FIG. 2 is similar to that of the electrochemical capacitor illustrated in FIG. 1, except for points which will be described below.

The electrolyte layer 14 includes an ionic liquid and a polymer compound. It is because of a similar reason to that in the case of the above-described cathode active material layer 11B and the above-described anode active material layer 12B. Specifically, since the ionic liquid is retained by the polymer compound in the gel-like electrolyte layer 14, a reduction in discharge capacity due to the ionic liquid in the electrolyte layer 14 is inhibited.

For example, specific description of the ionic liquid and the polymer compound included in the electrolyte layer 14 is similar to that of the ionic liquid and the polymer compound included in the cathode active material layer 11B and the anode active material layer 12B. The kinds of the ionic liquid and the polymer compound included in the electrolyte layer 14 may be the same as or different from those included in the cathode 11 and the anode 12. However, the kinds of the ionic liquid and the polymer compound in the electrolyte layer 14 are preferably the same as those in the cathode 11 and the anode 12. It is because compatibility between the materials is improved; therefore, high adhesion is allowed to be obtained.

The electrolyte layer 14 is preferably molded in a sheet shape in advance. It is because the electrolyte layer 14 is easily handled. It is to be noted that since the electrolyte layer 14 includes the ionic liquid, the electrolyte layer 14 may not additionally include a solvent (such as an organic solvent).

In the electrochemical capacitor, the cathode active material layer 11B and the anode active material layer 12B face each other with the electrolyte layer 14 in between, and the electrolyte layer 14 is adjacent to the cathode 11 and the anode 12. In this case, the electrolyte layer 14 plays a role in physically separating the cathode 11 and the anode 12 from each other; therefore, it is not necessary to additionally include a separator.

[Method of Manufacturing Electrochemical Capacitor]

The electrochemical capacitor illustrated in FIG. 2 is manufactured by similar steps to those of manufacturing the electrochemical capacitor illustrated in FIG. 1, except for points which will be described below.

First of all, the electrolyte layer 14 is formed. First, the ionic liquid and the polymer compound, and, if necessary, a solvent for viscosity adjustment or the like are mixed, and then stirred to form slurry. Next, a substrate such as a glass plate is coated with the slurry, and the slurry is dried to form a film (mold the slurry in a sheet shape). Finally, the film is stamped into a circular shape corresponding to the shapes of the cathode 11 and the anode 12.

After that, the cathode 11 and the anode 12 are laminated to allow the cathode active material layer 11B and the anode active material layer 12B to face each other with the electrolyte layer 14 in between. Therefore, the electrochemical capacitor illustrated in FIG. 2 is completed. It is to be noted that instead of forming the electrolyte layer 14 in a sheet shape in advance, the electrolyte layer 14 may be formed by directly coating the cathode active material layer 11B and the anode active material layer 12B with the slurry.

In the electrochemical capacitor, since the cathode 11 and the anode 12 include both of the ionic liquid and the polymer compound, as described above, in any cases, the ionic liquid is retained by the polymer compound. Moreover, since the electrolyte layer 14 also includes both of the ionic liquid and the polymer compound, the ionic liquid is also retained by the polymer compound in the electrolyte layer 14. Therefore, compared to the case illustrated in FIG. 1, the discharge capacity is less likely to be reduced; therefore, discharge characteristics are allowed to be further improved.

In particular, in the case where the electrolyte layer 14 is molded in a sheet shape in advance, the electrolyte layer 14 is easily handled; therefore, the steps of manufacturing the electrochemical capacitor are allowed to be simplified.

Other effects are the same as those in the case illustrated in FIG. 1.

Configurations of comparative examples relative to the electrochemical capacitors illustrated in FIGS. 1 and 2 are as follows.

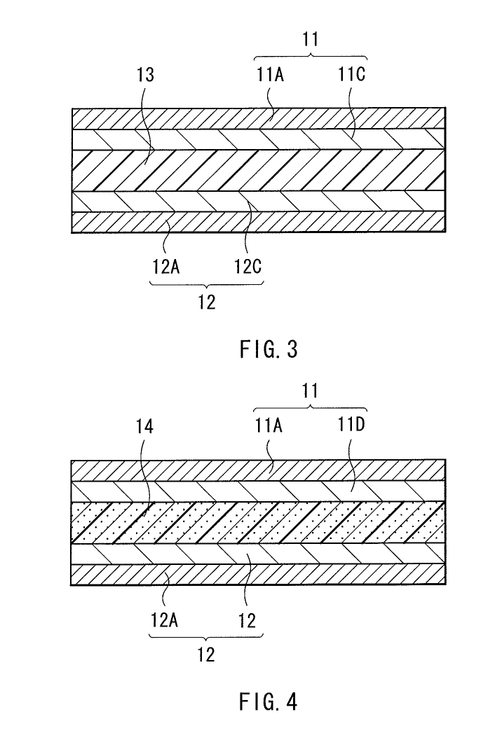

The case where the cathode 11 and the anode 12 do not fundamentally include the ionic liquid corresponds to, for example, the case where an electrolytic solution is used as illustrated in FIG. 3 relative to FIG. 1. In this case, the cathode 11 and the anode 12 include a cathode active material layer 11C and an anode active material layer 12C, respectively. Instead of the ionic liquid, the cathode active material layer 11C and the anode active material layer 12C are impregnated with an electrolytic solution including an electrolyte salt and an organic solvent, and the separator 13 is also impregnated with the electrolytic solution. Other configurations are similar to those in the case illustrated in FIG. 1.

Moreover, the case where the ionic liquid is included, but is not retained by the polymer compound corresponds to, for example, the case where the ionic liquid is included as illustrated in FIG. 4 relative to FIG. 2. In this case, the cathode 11 and the anode 12 include a cathode active material layer 11D and an anode active material layer 12D, respectively. The cathode active material layer 11D and the anode active material layer 12D are impregnated with the ionic liquid. Other configurations are similar to those in the case illustrated in FIG. 2.

### Examples

Next, examples of the invention will be described in detail below.

### Experimental Example 1

An electrochemical capacitor illustrated in FIG. 1 was formed by the following steps.

First of all, the cathode 11 was formed. First, 0.24 g of an active material (activated carbon), 0.24 g of an ionic liquid (DEME-BF₄), 0.03 g of a conductive agent (ketjen black), and 2 g of a solvent for viscosity adjustment (propylene carbonate) were mixed, and then stirred for 60 minutes in a vacuum environment. Next, 0.03 g of a polymer compound (PVDF-HFP) was added to a resultant mixture, and the mixture was stirred for 30 minutes to form slurry. Next, one surface of the cathode current collector 11A made of aluminum foil (with a thickness of 30 μm) was coated with an electrically-conductive adhesive, and then was coated with the slurry with use of a coater to allow the slurry to have a thickness of 400 μm. Next, a coated film was air-dried in an oven at 100° C. for 30 minutes, and then the coated film was further vacuum-dried under the same conditions. Next, the coated film was compression-molded with use of a roller press to form the cathode active material layer 11B. In this case, the total thickness of the cathode current collector 11A and the cathode active material layer 11B was 140 μm. Finally, the cathode current collector 11A including the cathode active material layer 11B formed thereon was stamped into a pellet shape (with an outside diameter of 8 mm).

Next, by similar steps to those of forming the cathode 11, the anode active material layer 12B was formed on one surface of the anode current collector 12A to form the anode 12 with a pellet shape.

Finally, the separator 13 made of a circular-shaped polyethylene film (with a thickness of 25 μm and an outside diameter of 15 mm) was impregnated with the ionic liquid (DEME-BF₄). After that, the cathode 11 and the anode 12 were laminated to allow the cathode active material layer 11B and the anode active material layer 12B to face each other with the separator 13 in between. Thus, the electrochemical capacitor (a sealed two-electrode cell manufactured by Takumi Giken Corporation) was completed.

### Experimental Example 2

An electrochemical capacitor illustrated in FIG. 2 was formed by similar steps to those in Experimental Example 1, except that, instead of the separator 13 impregnated with the ionic liquid, the electrolyte layer 14 was used.

In the case where the electrolyte layer 14 was formed, first, 0.5 g of an ionic liquid (DEME-BF₄), 0.25 g of a polymer compound (PVDF-HFP), and 1 g of a solvent for viscosity adjustment (propylene carbonate) were mixed, and then stirred to form slurry. Next, one surface of a glass plate was coated with the slurry, and then the slurry was dried at 100° C. with use of a heater to obtain the sheet-shaped electrolyte layer 14 (with a thickness of 60 μm). Finally, the electrolyte layer 14 was stamped into a pellet shape (with an outside diameter of 13 mm).

### Experimental Example 3

An electrochemical capacitor illustrated in FIG. 3 was formed by similar steps to those in Experimental Example 1, except that the cathode 11 and the anode 12 were formed by steps which will be described below.

In the case where the cathode 11 was formed, first, an active material (activated carbon) was stamped into a pellet shape (with an outside diameter of 8 mm) to form the cathode active material layer 11C. Next, as the electrolytic solution, a propylene carbonate solution (0.5 mol/kg) of tetraethylammonium tetrafluoroborate (TEABF₄) was prepared. Next, while the cathode active material layer 11C was immersed in the electrolytic solution, the cathode active material layer 11C was deaerated under reduced pressure for 24 hours to impregnate the cathode active material layer 11C with the electrolytic solution. Finally, the cathode current collector 11A made of aluminum foil (with a thickness of 30 μm) was stamped into a pellet shape (with an outside diameter of 8 mm), and then the cathode active material layer 11C was bonded to one surface of the cathode current collector 11A with use of an electrically-conductive adhesive.

In the case where the anode 12 was formed, by similar steps to those of forming the cathode 11, the anode active material layer 12C was formed on one surface of the anode current collector 12A, and was stamped into a pellet shape.

### Experimental Example 4

An electrochemical capacitor illustrated in FIG. 4 was formed by similar steps to those in Experimental Example 1, except that the cathode 11 and the anode 12 were formed by similar steps to those in Experimental Example 3, and the electrolyte layer 14 was formed by similar steps to those in Experimental Example 2.

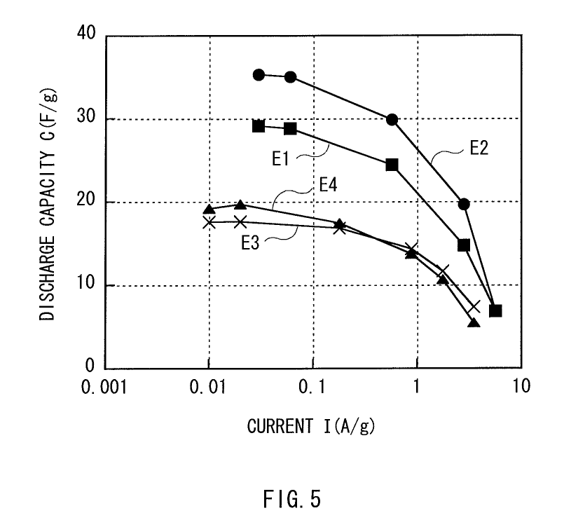

When a constant-current charge/discharge test (at a current of 2 mA and a voltage of 0 V to 2 V) was performed on these electrochemical capacitors of Experimental Examples 1 to 4, results illustrated in FIG. 5 were obtained. In FIG. 5, a horizontal axis indicates current I (A/g) per unit weight, and a vertical axis indicates discharge capacity C (F/g) per unit weight. The “unit weight” is based on a total weight of main components (the active material, the polymer compound, and the conductive agent) in the electrode. E1 to E4 in FIG. 5 indicate Experimental Examples 1 to 4, respectively. For reference, in Table 1, configurations of the electrochemical capacitors of Experimental Examples 1 to 4 are illustrated for comparison.

TABLE 1

| | | Experimental | Experimental | Experimental | Experimental |
|---|---|---|---|---|---|
| | | Example 1 | Example 2 | Example 3 | Example 4 |
| Configuration | | FIG. 1 | FIG. 2 | FIG. 3 | FIG. 4 |
| Electrode | Ionic | DEME—BF₄ | DEME—BF₄ | — | — |
| (Cathode, | Liquid | | | | |
| Anode) | Polymer | PVDF—HFP | PVDF—HFP | — | — |
| | Compound | | | | |
| | Electrolytic | — | — | TEABF₄ | TEABF₄ |
| | Solution | | | | |
| Electrolyte | Ionic | — | DEME—BF₄ | — | DEME—BF₄ |
| Layer | Liquid | | | | |
| | Polymer | — | PVDF —HFP | — | PVDF—HFP |
| | Compound | | | | |
| | Electrolytic | — | — | — | — |
| | Solution | | | | |
| Separator | Ionic | DEME—BF₄ | — | — | — |
| | Liquid | | | | |
| | Electrolytic | — | — | TEABF₄ | — |
| | Solution | | | | |

In the case where the electrode included both of the ionic liquid and the polymer compound (in Experimental Examples 1 and 2), the discharge capacity was extremely higher than that in the case where the electrode did not include both of them (in Experimental Examples 3 and 4). Moreover, in the case where the electrode included both of the ionic liquid and the polymer compound (in Experimental Examples 1 and 2), the discharge capacity was further higher in the case where the electrolyte layer also included both of the ionic liquid and the polymer compound. It is to be noted that, in the case where the electrolyte layer included both of the ionic liquid and the polymer compound (Experimental Examples 2 and 4), when the electrode did not include both of the ionic liquid and the polymer compound, sufficient discharge capacity was not obtained. Therefore, it is clear from these results that when the electrode includes both of the ionic liquid and the polymer compound, discharge characteristics are improved, and when the electrolyte layer also includes both of the ionic liquid and the polymer compound, the discharge characteristics are further improved.

Although the present invention is described referring to the embodiment and examples, the invention is not limited thereto, and may be variously modified. For example, the kinds of the ionic liquid and the polymer compound are not limited to those described above, and other kinds may be used. Moreover, the kinds of the active material, the ionic liquid, and the polymer compound in one of the electrodes may be the same as or different from those in the other electrode. Further, one or both of the electrodes may include both of the ionic liquid and the polymer compound. In these cases, compared to the case where none of the electrodes includes both of the ionic liquid and the polymer compound, discharge characteristics are allowed to be improved.

1. An electrochemical capacitor comprising:
an electrolyte between a pair of electrodes, the electrodes including an active material, an ionic liquid, and a polymer compound.

2. The electrochemical capacitor according to claim 1, wherein
the electrolyte includes an ionic liquid, and a separator is impregnated with the electrolyte.

3. The electrochemical capacitor according to claim 1, wherein
the electrolyte includes an ionic liquid and a polymer compound.

4. The electrochemical capacitor according to claim 3, wherein
the electrolyte has a sheet shape, and is disposed adjacent to the pair of electrodes.

5. The electrochemical capacitor according to claim 1, wherein
the ionic liquid has compatibility with the polymer compound.

6. The electrochemical capacitor according to claim 1, wherein
the polymer compound has thermoplasticity.

7. The electrochemical capacitor according to claim 1, wherein
the polymer compound is a copolymer of vinylidene fluoride and hexafluoropropylene.
